(19) United States
(12) Patent Application Publication
(10) Pub. No.: US 2008/0048518 A1
(43) Pub. Date: Feb. 28, 2008

(54) Hammer Brush for an Electric Machine

(76) Inventor: Robert Heitz, Rastatt (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 11/628,245

(22) PCT Filed: Jun. 14, 2005
(86) PCT No.: PCT/EP05/52736

§ 371 Date: Dec. 1, 2006

(30) Foreign Application Priority Data
Jun. 18, 2004 (DE) 10 2004 029 534.4

(51) Int. Cl. H01R 39/39; H01R 39/26; H02K 13/00

(52) U.S. Cl. 310/244; 310/253

(57) ABSTRACT

A hammer brush to be supported in pivoting fashion in a brush holder of an electric machine is equipped with a leaf spring which includes a fastening section for attachment to the brush holder an arm connected to the fastening section to which a carbon brush is fastened, and a section at the end of the arm which is bent at an angle toward the fastening section. The section at the end of the arm is bent toward the side of the arm oriented away from the carbon brush and is embodied as resilient.

### PRIOR ART

The invention is based on a hammer brush for an electric machine as generically defined by the preamble to claim 1. A hammer brush of this kind, to be supported in pivoting fashion in a brush holder of the electric machine is as a rule equipped with two leaf springs that include a fastening section for attachment to a brush holder, an arm that is connected to the fastening section and has a carbon brush fastened to it, and a section that is situated at the end of the arm and bent at an angle toward the fastening section. Assuring the necessary pressing force of the carbon in relation to the commutator requires the hammer brushes to be prestressed. When the hammer brush holder is mounted radially, the prestressed hammer brushes are spread open by their sections embodied as installation aids, which are supported against the commutator. This generates a high buckling load on the leaf springs of the hammer brushes, particularly when the installation aids first contact the commutator. This can cause damage to the surface of the commutator.

### ADVANTAGES OF THE INVENTION

The hammer brush for an electric machine, with the defining characteristics of claim 1, has the advantage over the prior art of simplifying installation of the hammer brush holder, improving positioning of the carbon in relation to the commutator, and reducing spring force tolerances. To this end, a hammer brush to be supported in pivoting fashion on a brush holder of an electric machine is provided with a leaf spring; the leaf spring includes a fastening section for attachment to the brush holder, an arm that is connected to the fastening section and has a carbon brush fastened to it, and a section that is situated at the end of the arm and bent at an angle toward the fastening section; the section is bent toward the side of the arm oriented away from the carbon brush.

Preferably, the resilient section is at least bent at an acute angle in relation to the arm. This yields more precisely defined spring forces.

It is advantageous for the spring characteristic curve if the arm and the resilient section are connected to each other by means of a bend.

The installation of the hammer brush into a component is facilitated by the fact that a preferably arc-shaped region that curves away from the arm is provided at the end of the resilient section, at the height of the carbon brush.

If a reinforcement—embodied in the form of a bead, bent edges, or an additional plate—is provided along the arm, then this prevents a tilting of the carbons induced by the torque generated by the spring force.

A brush holder, which is equipped with two hammer brushes that are mounted on the brush holder and protrude from it and in which the carbon brushes are oriented toward each other and the resilient sections are oriented away from each other, is easy to install. If, in a brush holder of this kind, the arms extend essentially parallel to each other in the uninstalled state. As a result, the contact force against a commutator is very slight during installation and is only exerted toward the end of the installation process.

This simplification of the installation is achieved even in an electric machine with at least one hammer brush of this kind. The same is true for an electric machine with a brush holder of this kind; the brush holder with the hammer brushes in front is situated in a recess; the hammer brushes rest against a commutator contained in the recess; and the recess has two side walls against which the resilient sections rest. The installation can also be simplified if the side walls are provided with insertion bevels for the resilient sections of the arms.

Other advantages and advantageous modifications ensue from the dependent claims and the specification.

### DRAWINGS

An exemplary embodiment is shown in the drawings and will be explained in detail in the subsequent description.

FIG. 1 shows a longitudinal section through an electric motor,

FIG. 2 shows a commutation device of the electric motor according to the section line II-II in FIG. 2, and

FIG. 3 shows the commutation device from FIG. 2 in the installed position.

### DESCRIPTION OF THE EXEMPLARY EMBODIMENT

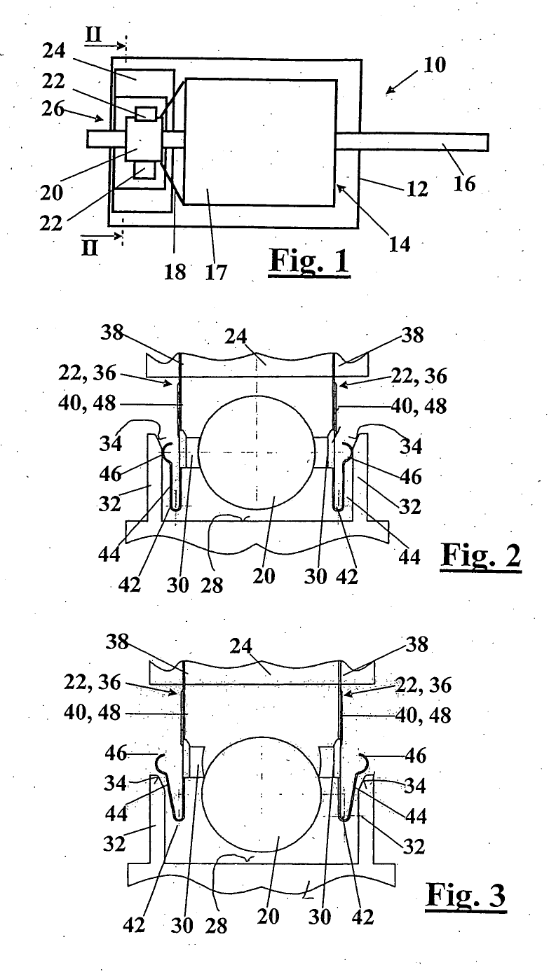

FIG. 1 shows a simplified longitudinal section through an electric motor 10, which can also be a generator. The electric motor 10 can be used in a motor vehicle, for example as a power seat adjuster, power window unit, wiper drive unit, fan, etc. The electric motor 10 has a housing 12 that accommodates an armature 14. The armature 14 has a shaft 16 and an armature core 17 with an armature winding that is not shown in detail. The armature winding is connected by means of wires 18 to a commutator 20. Two hammer brushes 22 situated on two radially opposite sides act on the circumference of the commutator 20. The hammer brushes 22 are attached to a brush holder 24. The commutator 20, the hammer brushes 22, and the brush holder 24 constitute a commutation device 26. The commutator 20 and part of the hammer brushes 22 are accommodated in a recess 28 that can be situated, for example, in a transmission housing.

FIG. 2 shows the commutation device 26 in a side view from the left in relation to the longitudinal section shown in FIG. 1. The brush holder 24, which is preferably made of plastic, extends essentially parallel to the shaft 16, which is not shown in detail in FIG. 2; the brush holder 24 can, however, also extend perpendicular to the shaft 16. The brush holder 24, with the hammer brushes 22 in front, is situated in the recess 28. The hammer brushes 22 rest with the carbon brushes 30 against the commutator 20 contained in the recess. The hammer brushes 22 in turn rest against two parallel side walls 32 of the recess 28. At their outer edge, the side walls 32 have respective insertion bevels 34 oriented toward each other, which function as installation aids.

The hammer brushes 22 to be supported in pivoting fashion on the brush holder 24 each have a leaf spring 36. Each leaf spring 36 has a fastening section 38 that is anchored to the brush holder 24. The current supply to the hammer brush 22 is furnished via the fastening section 38 or additional flexible wires. The fastening section 38 is adjoined by an arm 40 in the form of a leaf spring. The arm 40 is also attached to the carbon brush 30.

A resilient section 44 that is bent at an angle toward the fastening section 38 or the brush holder 24 adjoins the end of the arm 40, preferably by means of a bend 42 with a 1 to 3 mm radius. In the uninstalled state (FIG. 3), the angled section 44 is bent at an acute angle of 5 to 25° in relation to the arm 40. The resilient section 44 is bent toward the side of the arm 40 oriented away from the carbon brush 30. At the end of the angled section 44, approximately at the height of the carbon brush 30, there is a preferably arc-shaped region 46 that curves away from the arm 40. The region 46 essentially corresponds to a semicircle.

A reinforcement 48 is provided along the arm 40, between the fastening section 38 and the arc 42. The reinforcement 48 can be embodied in the form of a bead or else the two side edges along the arm 40 can be bent at an angle. It is also possible, for example, for the reinforcement to be a welded-on plate.

As is clear from FIG. 3, at least in the uninstalled state, the arms 40 extend essentially parallel to each other. The carbon brushes 30 are oriented toward each other and the resilient sections 44 are oriented away from each other. The arms 40 serve to preposition the carbon brushes 30. During insertion of the brush holder 24 and the hammer brushes 22, first the angled sections 44 are compressed and placed under stress by the contact of the arc-shaped regions 46 against the insertion bevels 34. This can occur in such away that the carbon brushes 30 are pressed against the commutator 20 only in the radial direction, without dragging along it tangentially. As a result, no scratching of the surface occurs. It can, however, be permissible for the carbon brushes 30 to still drag slightly against the surface of the commutator 20. The arms 40 are pivoted only by the position offset between the commutator 20 and the brush holder 24, thus making it possible to provide the reinforcements that prevent an undesirable tilting of the carbon brushes 30, which can be induced by the torque generated by the spring force.

The hammer brushes 22 can also be accommodated in the recess 28 itself. The insertion bevels 34 are then provided in a counterpart piece, for example a plastic holder or transmission cover.

1-10. (canceled)

11. A hammer brush to be supported in pivoting fashion in a brush holder of an electric machine, the hammer brush including a leaf spring comprising
a fastening section for attachment to the brush holder,
an arm connected to the fastening section to which a carbon brush is fastened,
and a section at the end of the arm which is bent at an angle toward the fastening section,
the section being bent toward the side of the arm oriented away from the carbon brush and being embodied as resilient.

12. The hammer brush according to claim 11, wherein the resilient section is at least bent at an acute angle in relation to the arm.

13. The hammer brush according to claim 11, wherein the arm and the resilient section are connected to each other by means of a bend.

14. The hammer brush according to claim 12, wherein the arm and the resilient section are connected to each other by means of a bend.

15. The hammer brush according to claim 11, further comprising a preferably arc-shaped region that curves away from the arm at the end of the resilient section at the height of the carbon brush.

16. The hammer brush according to claim 12, further comprising a preferably arc-shaped region that curves away from the arm at the end of the resilient section at the height of the carbon brush.

17. The hammer brush according to claim 13, further comprising a preferably arc-shaped region that curves away from the arm at the end of the resilient section at the height of the carbon brush.

18. The hammer brush according to claim 11, further comprising a reinforcement extending along the arm, the reinforcement being in the form of a bead, bent lateral edges, or an additional plate.

19. The hammer brush according to claim 12, further comprising a reinforcement extending along the arm, the reinforcement being in the form of a bead, bent lateral edges, or an additional plate.

20. The hammer brush according to claim 13, further comprising a reinforcement extending along the arm, the reinforcement being in the form of a bead, bent lateral edges, or an additional plate.

21. A brush holder with at least two hammer brushes according to claim 11, mounted on the brush holder and protruding from the brush holder, wherein the carbon brushes are oriented toward each other and the resilient sections are oriented away form each other.

22. A brush holder with at least two hammer brushes according to claim 18, mounted on the brush holder and protruding from the brush holder, wherein the carbon brushes are oriented toward each other and the resilient sections are oriented away from each other.

23. The brush holder according to claim 21, wherein the arms extend essentially parallel to each other, at least in the uninstalled state.

24. The brush holder according to claim 22, wherein the arms extend essentially parallel to each other, at least in the uninstalled state.

25. An electric machine equipped with at least one hammer brush according to claim 11.

26. An electric machine equipped with at least one hammer brush according to claim 18.

27. An electric machine equipped with a brush holder according to claim 22, the brush holder with the hammer brushes in front is situated in a recess; wherein the hammer brushes rest against a commutator contained in the recess; and wherein the recess has two side walls against which the resilient sections rest.

28. An electric machine equipped with a brush holder according to claim 23, the brush holder with the hammer brushes in front is situated in a recess; wherein the hammer brushes rest against a commutator contained in the recess; and wherein the recess has two side walls against which the resilient sections rest.

29. The electric machine according to claim 27, wherein the side walls are provided with insertion bevels for the hammer brushes.

30. The electric machine according to claim 28, wherein the side walls are provided with insertion bevels for the hammer brushes.
